(19) United States
(12) Patent Application Publication
(10) Pub. No.: US 2024/0330905 A1
(43) Pub. Date: Oct. 3, 2024

(54) NFT INFORMATION MANAGEMENT SYSTEM, AND NFT INFORMATION MANAGEMENT PROGRAM

(71) Applicant: MONOGOKORO CO.,LTD, Mitaka-shi, Tokyo (JP)

(72) Inventors: Kyuuhei KUWATA, Mitaka-shi, Tokyo (JP); Tadamasa SUZUKI, Mitaka-shi, Tokyo (JP)

(21) Appl. No.: 18/573,725

(22) PCT Filed: Jun. 22, 2022
(86) PCT No.: PCT/JP2022/024951

§ 371 Date: Dec. 22, 2023

(30) Foreign Application Priority Data
Jun. 25, 2021 (JP) 2021-105557

(51) Int. Cl. G06Q 20/36

(52) U.S. Cl. CPC G06Q 20/3678

(57) ABSTRACT

By adding confidential information to management information of an NFT, an asset value of the NFT is increased. An NFT information management system that adds specific information to an NFT (Non-Fungible Token) that holds an identifier on a blockchain, the system includes a storage part that stores an NFT in each user page on a network, and a confidential information adding part that adds arbitrary confidential information to the NFT stored in the storage part in an encrypted state. The confidential information is encrypted and added to the NFT can be viewed only when it is decrypted by using decryption information.

### TECHNICAL FIELD

The present invention relates to a technology to add specific information to an NFT (Non-Fungible Token) that holds an identifier on a blockchain.

### BACKGROUND ART

Traditionally, digital data has not been considered to have an asset value like physical jewelry or a painting because it can be easily copied or falsified, but a blockchain has changed this situation, making digital data on a blockchain difficult to copy or falsify and making it possible to give an asset value to digital data by having mutual verification among participants. What made it possible for digital data to have a unique value is an NFT (Non-Fungible Token). An NFT is “digital data with an unforgeable certificate of authenticity and certificate of ownership” and is issued and transacted on a blockchain like a crypto asset (virtual currency).

A technology for using an NFT for management of a transaction or the like on an object different from an NFT is disclosed in Patent Document 1. That is a method of, for management of an object associated with an NFT issued by a blockchain that is capable of executing a smart contract, controlling the NFT. This method comprises preparing an object to which data for invoking a smart contract is given, a management server accepting network access using the data given to the object, and the management server that accepted the network access invoking the smart contract by using the data to execute the control on the NFT.

In addition, an asset right management system based on a blockchain is disclosed in Patent Document 2. This asset right management system issues an asset smart contract corresponding to an asset on a blockchain network in advance, executes the asset smart contract to generate a homogenized ownership token that indicates the ownership of the asset, and generates a usage right token, which corresponds based on the ownership token and indicates the right of usage of the asset that is not homogenized. When the asset smart contract receives the amount of revenue earned through the transaction of the usage right token, the usage right token is transferred, and the amount of profit sharing is calculated and dispatched to the owner, achieving the technological effect of improving the convenience of asset right management and revenue.

### PRIOR ART DOCUMENT

### Patent Document

Patent Document 1: Specification of U.S. Pat. No. 6,710,401. Patent Document 2: Japanese Unexamined Patent Application Publication No. 2021-072116

### SUMMARY OF THE INVENTION

### Problems to be Solved by the Invention

On a blockchain, it is configured that a general user can earn royalties by associating an NFT with an item and reselling it, but if the item is created by, for example, a company or an individual, there is a risk of causing a legal trouble if a third party associates an NFT with the item without permission, so the right of the creator of the product needs to be managed to prevent the occurrence of such problems. By managing the right of the creator of the product, it becomes possible to set officially approved royalties between the creator of the product and the general user, which solves copyright problems and increases the brand power of the creator. It is anticipated that NFT commercial transactions on blockchains will become more and more active in the future, and a system to properly manage assets on blockchains as well as to increase values of the assets is expected to be established. The present invention has been made in view of such a situation and has an object to provide an NFT information management system and an NFT information management program that can increase an asset value of an NFT by adding confidential information, which can be viewed only by the owner of the NFT, to the NFT management information.

### Means to Solve the Problems

(1) In order to achieve the above-described object, the present invention has taken steps as follows. That is, an NFT information management system according to the present invention is an NFT information management system that adds specific information to an NFT (Non-Fungible Token) that holds an identifier on a blockchain, the system comprising a storage part that stores the NFT in each user page provided on a network and a confidential information adding part that adds arbitrary confidential information to the NFT stored in the storage part in an encrypted state, wherein the confidential information encrypted and added to the NFT can be viewed only when it is decrypted by using decryption information.

(2) Further, in an NFT information management system according to the present invention, the confidential information adding part adds new confidential information in a state where the confidential information already added is retained when the ownership of the NFT is transferred.

(3) Further, in an NFT information management system according the to the present invention, confidential information is at least one of text data, voice data, video data, or still image data.

(4) Further, in an NFT information management system according to the present invention, the confidential information is information that indicates a right to obtain ownership of an NFT associated with a specific product.

(5) Further, in an NFT information management system according to the present invention, the user who obtained the ownership of the NFT is recorded in the NFT as a primary owner, and revenue is given to the user through the blockchain every time the NET is resold.

(6) Further, an NFT information management program according to the present invention is an NFT information management program that adds specific information to an NFT (Non-Fungible Token) that holds an identifier on a blockchain, the program comprising at least processing of storing an NFT in each user page provided on a network; processing of adding arbitrary confidential information to the NFT stored in an encrypted state; and processing of decrypting the confidential information encrypted and added to the NFT by using decryption information, wherein the confidential information can be viewed only when it is decrypted.

(7) Further, in an NFT information management system according to the present invention, new confidential information is added in a state where confidential information already added is retained when the ownership of the NFT is transferred.

(8) Further, in an NFT information management program according to the present invention, the confidential information is at least one of text data, voice data, video data, or still image data.

(9) Further, in an NFT information management program according to the present invention, the confidential information is information that indicates a right to obtain ownership of an NFT associated with a specific product.

(10) Further, in an NFT information management program according to the present invention, the user who obtained the ownership of the NET is recorded in the NFT as a primary owner, and revenue is given to the user through the blockchain every time the NFT is resold.

### Effect of the Invention

According to the present invention, it becomes possible to increase an asset value of an NFT because confidential information is added to one and only NFT.

### BRIEF DESCRIPTION OF THE DRAWINGS

FIG. 1 is a diagram showing an overview configuration of an NFT information management system according to an embodiment of the present invention.

FIG. 2 is a diagram showing an overview of an NFT commercial transaction that has been conducted on a conventional blockchain.

FIG. 3 is a diagram showing an example of screen transitions when an owner of a product adds confidential information to an electronic certificate of an NFT.

FIG. 4 is a diagram showing one example of confidential information added to a digital product.

FIG. 5 is an example of a screen display when using a password setting function of WORD.

FIG. 6A is a diagram showing how to upload a WORD file as confidential information to an electronic certificate of an NFT.

FIG. 6B is a flow chart showing an overview of a process of an owner of a product adding confidential information to an electronic certificate of an NFT.

FIG. 7 is a diagram showing how the user A logs in to an NFT information management system according to the present embodiment and selects an NFT to purchase on a product list page.

FIG. 8 is a diagram showing one example of My Page of the user A who purchased an NFT.

FIG. 9A is a diagram showing how a secret message is displayed.

FIG. 9B is a flow chart showing steps from a purchase of an NFT to a view of a secret message.

### DETAILED DESCRIPTION OF EMBODIMENTS

### [A Configuration of the Present Invention]

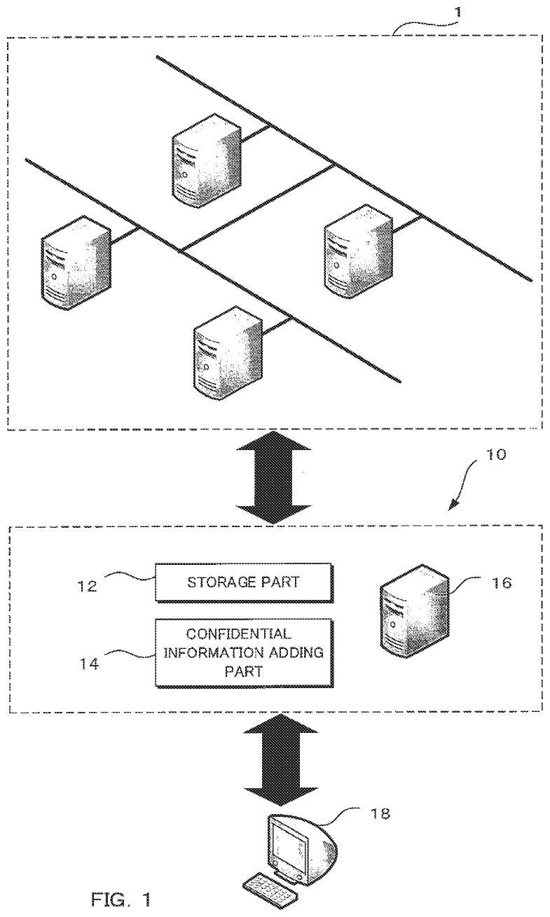

FIG. 1 is a diagram showing an overview configuration of an NFT information management system according to an embodiment of the present invention. The NFT information management system 10 according to the present invention is the NFT information management system 10 that adds specific information to an NFT (Non-Fungible Token) that holds an identifier on the blockchain 1, the system comprising the storage part 12 that stores an NFT in each user page provided on a network and the confidential information adding part 14 that adds arbitrary confidential information to the NFT stored in the storage part 12 in an encrypted state. The confidential information encrypted and added to the NFT can be viewed only when it is decrypted by using decryption information on the terminal device 18 or the like.

The blockchain 1 adopts a configuration in which data such as transaction information is synchronized and recorded by combining cryptographic technologies on a plurality of computers configuring a distributed network. It is called a blockchain because it is a system in which transaction data for a certain period of time is compiled in blocks and computers verify each other, connect, and store correct record like a chain. It is also sometimes called a “distributed ledger.” The system of the blockchain 1 is that a database is built by generating units of data called blocks and connecting them like a chain in chronological order. Each block has a “hash value (a value calculated by a hash function)” of the previous one in the connected blocks, and it is possible to trace the history that the data has been transitioning by going back to previous hash values.

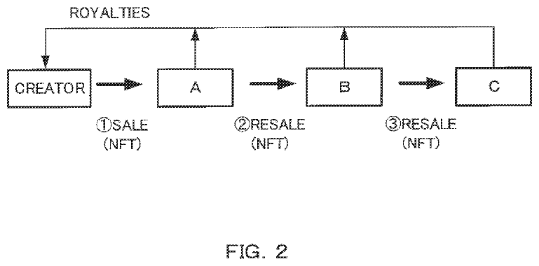

NFT commercial transactions have traditionally been conducted on such blockchains. FIG. 2 is a diagram showing an overview of an NFT commercial transaction that has been conducted on a conventional blockchain. (1) When a creator of a product (a creative work or the like) sells an NFT to another person, A, the ownership is transferred to A, and A pays a fee to the creator in exchange for the product. At this point, the fact that the ownership has been transferred is written to the blockchain system of the NFT on digital data. This allows the flow and ownership of the item to be grasped with a certificate of the NFT. In addition, revenue is given to the creator for every resale. The revenue given to the creator here is often set at a certain percentage of the sales price by an agreement. (2) Next, A, who has become the owner, resells the product to B. The fact that the ownership has been transferred from A to B is written to the certificate of the NFT. B pays A the product fee. At this point, a certain percentage of the resale price is given to the creator as revenue in the NFT system. (3) Next, B, who has become the owner, resells the product to C. The fact that the ownership has been transferred from B to C is written to the certificate of the NFT. C pays B the product fee. At this point, a certain percentage of the resale price is given to the creator as revenue in the NFT system.

In this manner, an in NFT commercial transaction on a conventional blockchain, a certain percentage of a resale fee is given to a creator as revenue for every resale, which has the following advantages and disadvantages. That is, the advantages include that the creator semi-permanently receives revenue every time the product is resold. Also, since the ownership of the item is properly managed, the distinction between the item and its copy is clearly defined. Furthermore, the more famous a product becomes, the more its value increases. The more copied products are distributed, the more the value of the original increases. On the other hand, the disadvantage is that it may only work for “rare products” or “limited products” by nature. In order for the creator to earn revenue, distribution (resale) must occur. An embodiment of the present invention makes it possible to overcome this disadvantage.

### [A Concept of the Present Invention]

In the present embodiment, as one example, thought of a creator is described in an electronic certificate of an NFT by text data, still image data, video data, voice data, or a combination of these. For example, the thought embodied in a painting by a well-known painter is information that cannot be known originally unless it is expressed. However, by describing the thought (for example, a secret message in text data) of the creator (in this case, the painter) in the electronic certificate of the NFT, the ownership of the painting is transferred, and only the purchaser/purchasers can know the secret message and prove the ownership.

That is, “the painting X painted by the painter (creator)” is treated as an NFT, and thought of the painter (creator) is added as encrypted confidential information to the electronic certificate of the NFT in text data or the like. After that, if the painting X is sold to a person, A, the fee is paid by A to the painter (creator), and the ownership of the painting X is transferred to A. A is given a password to decrypt the confidential information as the owner of the painting X, and A becomes able to view the text data that can only be viewed by himself/herself.

Moreover, the owner of the painting X can add new thought about the painting X as confidential information to the electronic certificate of the NET corresponding to the painting X. For example, famous paintings such as “Mona Lisa” are originally highly valuable, but their recognition may increase due to, for example, being stolen or copies being distributed, and as a result, the value of the original piece may increase even more. It can be said that “Time makes a story, which increases a value of an original piece.” Furthermore, by adding the thought of the owner in addition to the story created by the time, it becomes possible to know the story that can only be known at the time of owning the product.

[A Secret Message and an Additional Message that can Only be Known by an Owner in a Blockchain of an NFT]

In the present embodiment, there is a feature of thought, wishes, backgrounds, memories, feelings, and messages embodied in a product (an item or a work) being able to be described as a secret message on a blockchain of an NFT when ownership of the item is transferred, including sales and purchases.

By using a blockchain of an NFT (non-fungible token), it is possible to prove that a message (words, data/images, or videos) of a creator or a maker can only be known and possessed by its owner. This allows thought embodied in a product to be information that can only be known by a purchaser/purchasers, and thus can be offered as one and only thing that has an additional value.

Further, a purchaser/purchasers can obtain a right to add a message (words, data/images, or videos) to the product by using the blockchain of the NFT, so that their thought can be preserved and passed on as data even when the product is resold. Every time the ownership is transferred, a message (confidential information) is added by using the blockchain of the NFT, and it becomes something that has a story accompanied over time. In other words, in a system using a blockchain, thought of persons who owned an NFT continues to be added, and the story associated with the product continues to be passed on.

For example, a picture book sent by a celebrity to a facility in a disaster area is valuable, and if the thought left by the celebrity in a blockchain of an NFT is embodied in the NFT of the picture book and the number of messages increases every time the owner changes, it is believed that the value of the picture book increases.

### [Adding Confidential Information to an Electronic Certificate of an NFT]

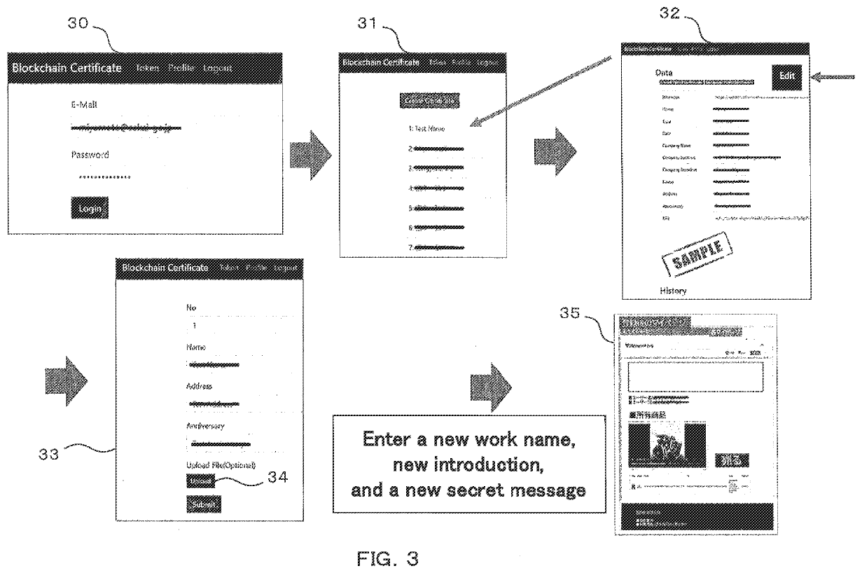

FIG. 3 is a diagram showing an example of screen transitions when an owner of a product adds confidential information to an electronic certificate of an NFT. The owner can log in by entering an ID (e-mail address) and a password on the login screen 30. Then, on the after-login screen 31, when the item of an electronic certificate is selected, it transitions to the content display screen 32, and it becomes possible to edit information on the editing screen 33. On the editing screen 33, the owner can enter a “new work name,” “new introduction,” and “new confidential information (a secret message).” “New confidential information (a secret message)” can be added by pressing the Upload button 34 and based on the following examples of steps described below. When the editing is completed, information about the product is displayed on the owner's My Page 35. In addition, the “Name” in FIG. 3 is only a tentative name and does not refer to a real person.

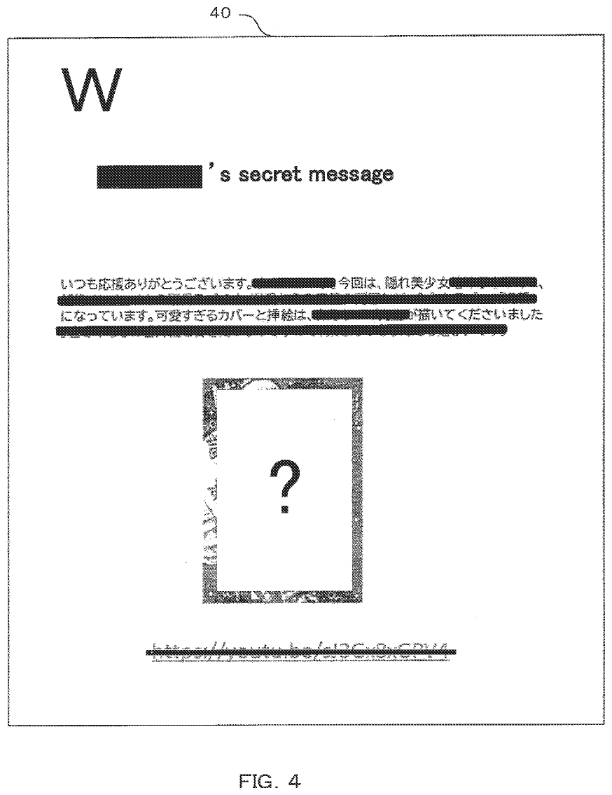

FIG. 4 is a diagram showing one example of confidential information added to a digital product. Here, for example, the file 40 created as confidential information by an application software called WORD is shown. The file 40 shall contain still image data and text data. When encrypting this file 40, in the present embodiment, an example of encrypting confidential information by using a password setting function of WORD is shown, but the present invention is not limited to this, and it is also possible to adopt a method in which a password is set on the system, and the owner is asked to enter the password when pressing the Download button.

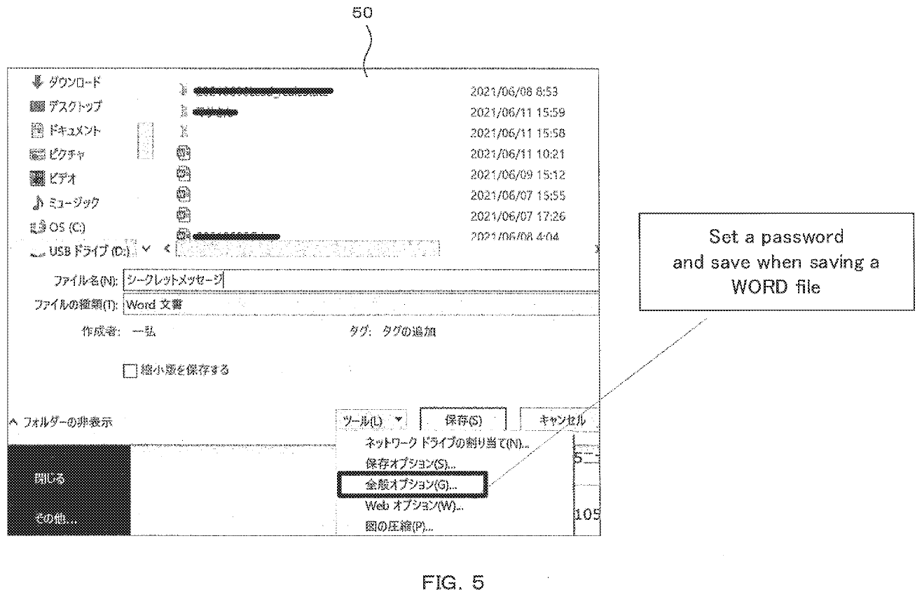

FIG. 5 is an example of a screen display when using a password setting function of WORD. As shown in FIG. 5, when saving a WORD file, the dialog box 50 to select the file is opened and an option to set a password can be selected. In this manner, it becomes possible to encrypt a WORD file as confidential information.

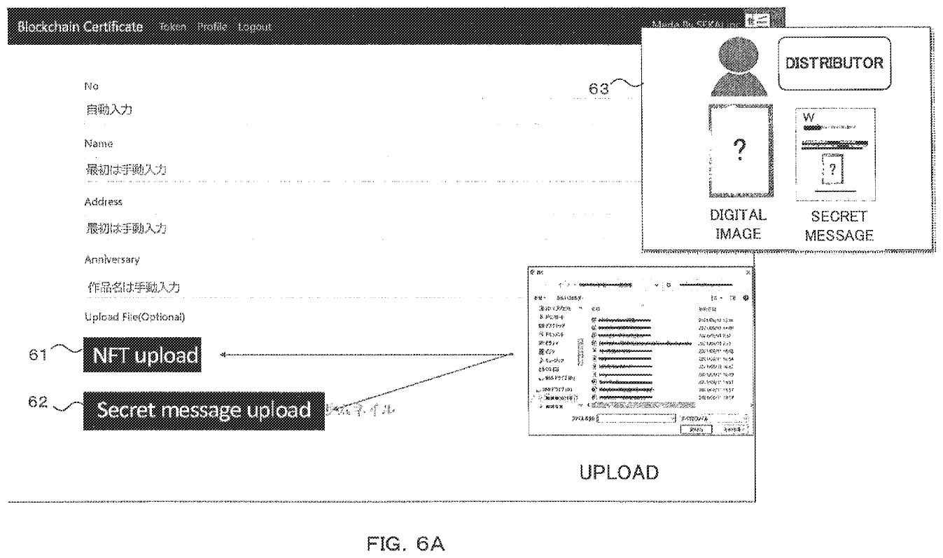

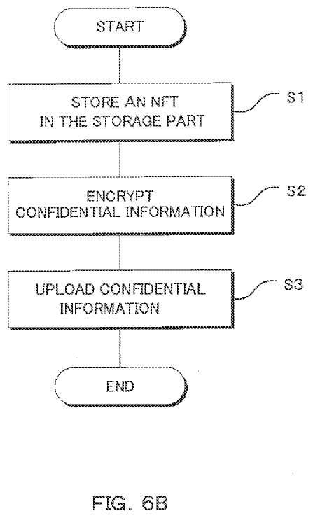

FIG. 6A is a diagram showing how to upload a WORD file as confidential information to an electronic certificate of an NFT. On the editing screen, when pressing the Secret message upload button 62, a dialog box opens, which enables the owner to select the desired WORD file and upload it. Similarly, when pressing the NFTupload button 61, it becomes possible to upload an NFT. The screen example 63 shows an uploaded digital product and how a secret message has been uploaded.

FIG. 6B is a flow chart showing an overview of a process of an owner of a product adding confidential information to an electronic certificate of an NFT. First, an NFT created or purchased is stored in the storage part 12 (step S1). Next, confidential information is encrypted by using the method described above (step S2). Then, the encrypted confidential information is uploaded to the NFT information management system (step S3), and the process ends. This enables confidential information (a secret message) to be added to an electronic certificate of an NFT.

### [From a Purchase of an NFT to a View of a Secret Message]

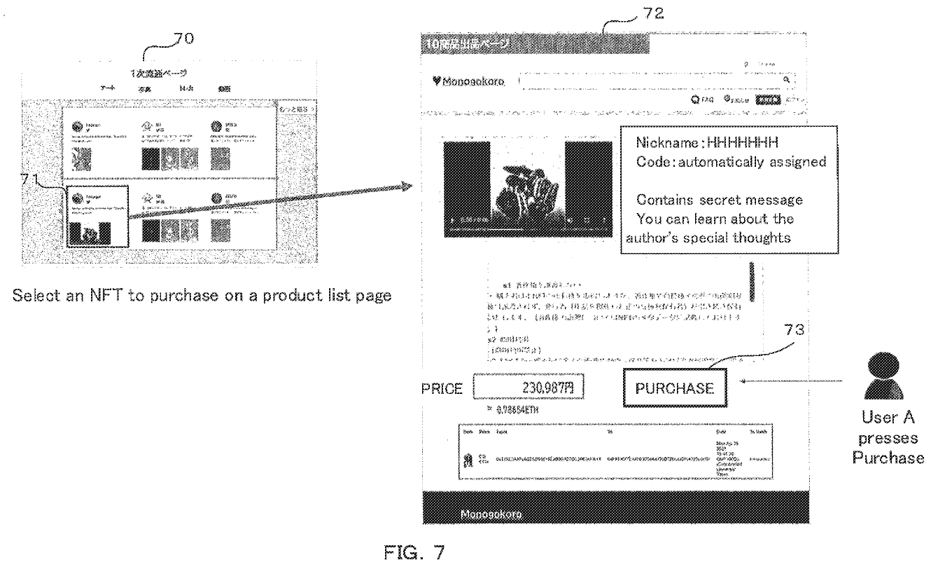

FIG. 7 is a diagram showing how the user A logs in to an NFT information management system according to the present embodiment and selects an NFT to purchase on a product list page. In FIG. 7, the product list page 70 shows a plurality of NFT thumbnails and shows that one of them, the NFT thumbnail 71 is selected. When the NFT thumbnail 71 is selected, the product selling page 72 is opened, which allows the contents of the NFT thumbnail 71 to be viewed. In the product selling page 72, details of the NFT of the owner “Nickname: HHHHHHH” are displayed. When the user A presses the Purchase button 73, it becomes possible to purchase the NFT.

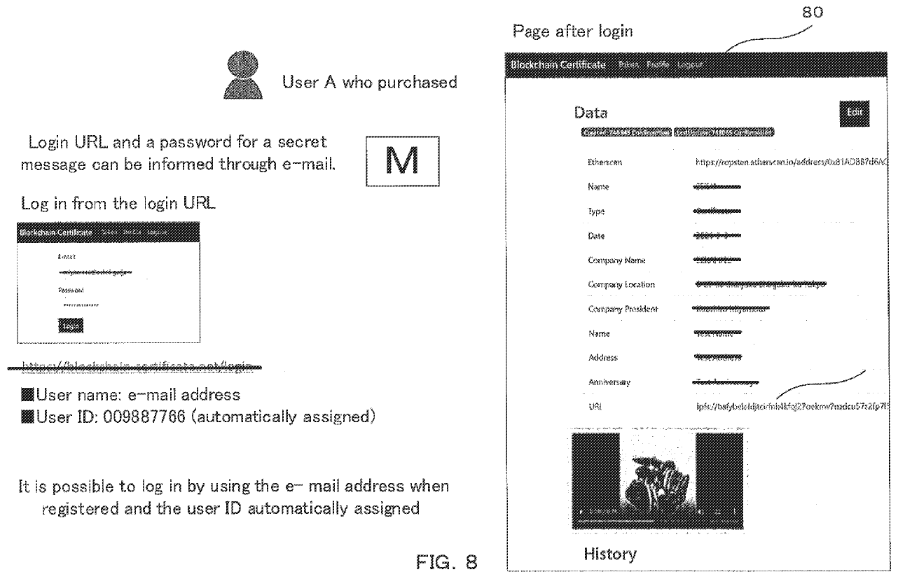

FIG. 8 is a diagram showing one example of My Page of the user A who purchased an NFT. The user A who purchased an NET obtains a login URL and a password for a secret message from the NFT information management system through e-mail. Here, it is assumed that it is possible to log in by using the e-mail address used when user information was registered in the NFT information management system and the user ID automatically assigned by the system. When the user A logs in, the information of the purchased NFT is displayed on the screen showing the after-login page 80. The URL 81 to view the secret message is shown in the lower right corner of the paper in FIG. 8.

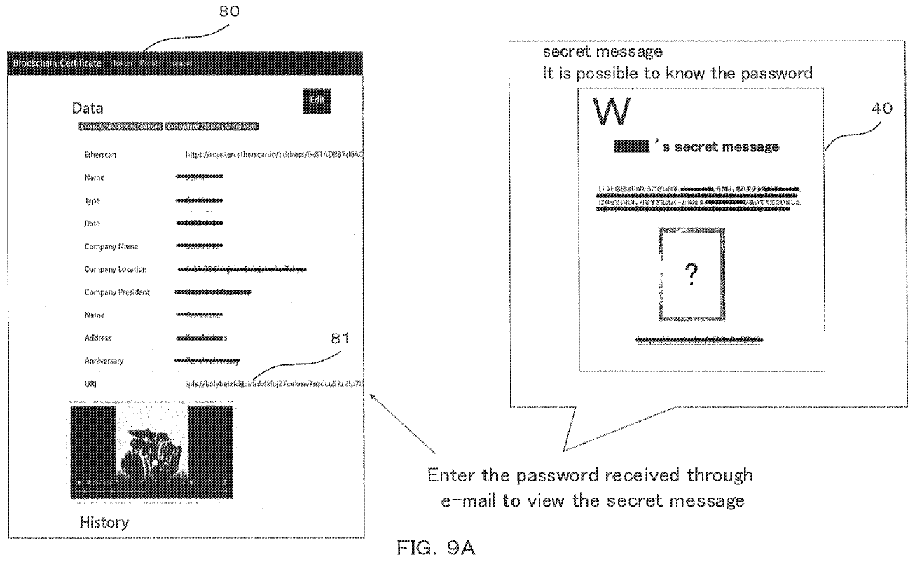

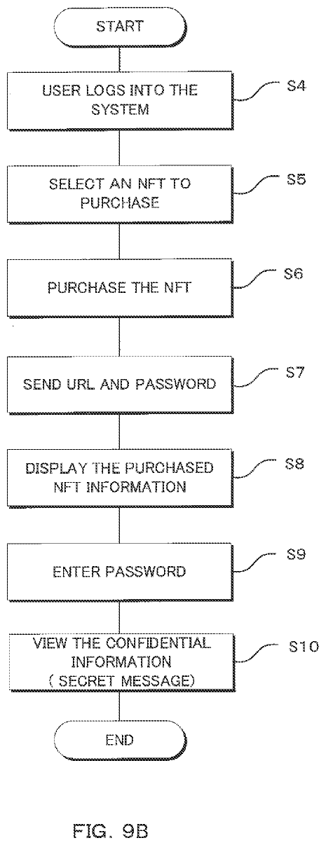

FIG. 9A is a diagram showing how a secret message is displayed. As shown in FIG. 9A, the user A can view the file 40 as confidential information after clicking the URL 81 on the screen showing the after-login page 80 and entering the password obtained through e-mail.

FIG. 9B is a flow chart showing steps from a purchase of an NFT to a view of a secret message. First, the user A logs into the NFT information management system according to the present embodiment (step S4). Next, when the user A selects an NFT to purchase on a product list page, a product selling page is opened and the contents of the NFT thumbnail can be viewed (step S5). When the user A presses the Purchase button, it becomes possible to purchase the NFT (step S6). When the user A purchases the NFT, a login URL and a password for a secret message are sent to the user A from the NFT information management system through e-mail (step S7). When the user A logs in, information on the purchased NFT is displayed (step S8). After the user A clicks the URL on the screen showing the after-login page and enters the password obtained through e-mail by the user A (step S9), the file is displayed as confidential information (step S10). This enables the user A to view the confidential information (the secret message) that can only be viewed by himself/herself.

### A Modified Example

As explained above, the NFT information management system according to the present embodiment has a feature of secret information (confidential information), which can be known only by the owner associated with the product, being added, in the management of the asset based on the blockchain.

Here, regarding the method of access to the confidential information, it is possible to adopt a form of the owner receiving to the e-mail address registered when the product was purchased, as well as to adopt a form of checking in a document enclosed with the product when the product arrived. In addition, regarding the management of a password, it is possible to adopt a form in which the user of the NFT (product manager) manages the password, or to adopt a form in which the management entity can be changed for each purchaser at the same time as owning.

Further, in the box where secret information, that can only be known by the owner, is stored, it is possible to describe images, videos, voices, languages (letters), thoughts and wishes for the work, as well as services associated with the product or the product provider. For example, this can be information that indicates special additional services such as discount tickets, advance tickets, handshake event tickets, or tickets that are beneficial for the next purchase.

For example, when an NFT is associated with a company's own product on a blockchain, the royalty is given to the company every time the product is resold secondarily or tertiarily, but there is a risk of causing a legal trouble if an NFT is associated with another company's product. However, in the NET information management system according to the present embodiment, when purchasing another company's product (an NFT), a password to purchase a new product is described in a secret message as confidential information, and it transitions to the website of the product of another company, and it is possible to use the password as the right to purchase the next new product. Originally, only that another company can associate an NFT with the new product, but according to the NFT information management system according to the present embodiment, it is possible for an individual to associate an NFT with that new product under his/her own name. This allows a general person to become the owner of the NFT of that new product, which will increase the purchasing desire, and it is expected to revitalize the NFT market. In addition, when that purchaser resells the product to another person, it will be bought and sold on the partner page of another company's new product, but the owner of the NFT will be recorded as the name of the person who made the purchase. This results in a royalty being given to the first purchaser every time the product is resold. In this manner, by utilizing secret messages, it is possible to give not only a right to associate an NFT with a product but also various other rights.

As explained above, the NFT information management system according to the present embodiment can embody a fading message of a creator or owner's mind in a blockchain of an NFT by adding the message of the owner's mind, which has not been surfaced, to an electronic certificate as confidential information, so that information known only by the owner can be obtained together with the product.

As a result, the more ownership is transferred, the more a story is added to the product, which becomes the added value of the product and can increase the purchasing desire.

In addition, the present international application claims priority under Japanese Patent Application No. 2021-105557, filed on Jun. 25, 2021, and the entire content of Japanese Patent Application No. 2021-105557 is applied to the present international application.

### EXPLANATION OF THE SYMBOLS

1 blockchain
10 NFT information management system
12 storage part
14 confidential information adding part
18 terminal device
30 login screen
31 after-login screen
32 content display screen
33 editing screen
34 Upload button
35 My Page
40 file
50 dialog box
61 NFTupload button
62 Secretmessageupload button
63 screen example
70 product list page
71 NFT thumbnail
72 product selling page
73 Purchase button
80 screen showing the after-login page

The invention claimed is:

1. An NFT information management system that adds specific information to an NFT (Non-Fungible Token) that holds an identifier on a blockchain, the system comprising:
a confidential information adding part that adds encrypted confidential information, which is at least one of text data, voice data, video data, or still image data associated with a specific product and provided based on a person's intention, to the NFT associated with a specific product;
a storage part that stores the NFT in a user page of a purchaser who purchased the NFT provided on a network, wherein
the encrypted confidential information can be viewed only when it is decrypted by using decryption information given to the purchaser who purchased the NFT.

2. The NFT information management system according to claim 1, wherein
the confidential information adding part adds new confidential information in a state where the confidential information already added is retained based on the control by the purchaser who purchased the NFT.

3. The NFT information management system according to claim 1, wherein
a creator of maker of the specific product is recorded in the NFT as a primary owner, and revenue is given to the creator or maker of the specific product through the blockchain every time the NFT is resold.

4. (canceled)

5. (canceled)

6. An NFT information management program that adds specific information to an NFT (Non-Fungible Token) that holds an identifier on a blockchain, the program comprising at least:
processing of adding encrypted confidential information, which is at least one of text data, voice data, video data, or still image data associated with a specific product and provided based on a person's intention, to the NFT associated with the specific product;
processing of storing the NFT in a user page of a purchaser who purchased the NFT provided on a network; and
processing of decrypting the encrypted confidential information by using decryption information, wherein
the encrypted confidential information is information that can be viewed only when it is decrypted by using decryption information given to the purchaser who purchased the NFT.

7. An NFT information management system according to claim 6, wherein
new confidential information is added in a state where confidential information already added is retained based on the control by the purchaser who purchased the NFT.

8. (canceled)

9. (canceled)

10. The NFT information management program according to claim 6, wherein
the creator or maker of the specific product is recorded in the NFT as a primary owner, and revenue is given to the creator or maker of the specific product through the blockchain every time the NFT is resold.
